(19) United States
(12) Patent Application Publication
(10) Pub. No.: US 2011/0086155 A1
(43) Pub. Date: Apr. 14, 2011

(54) Ginger konnyaku noodle and method of preparing thereof

(76) Inventor: Seitaro Nakaoka, Santa Monica, CA (US)

(21) Appl. No.: 12/587,505

(22) Filed: Oct. 9, 2009

(51) Int. Cl. A23L 1/0528; A23L 1/22

(52) U.S. Cl. 426/573

(57) ABSTRACT

Disclosed is a ginger konnyaku (konjac) noodle (also called ito-konnyaku or shirataki) and a method of preparing thereof.

The ginger konnyaku noodle is a coagulate food comprising raw material of konnyaku and ginger as a low-calorie diet.

Adding ginger to any konnyaku products has an effect to reduce the characteristic smell that these items have.

### BACKGROUND OF THE INVENTION

Present invention relates to a ginger konnyaku (konjac) noodle (also called ito-konnyaku or shirataki) and method of preparing thereof.

Heretofore, a ginger, though its flavor and taste are good and attractive, had been considered too hard to get a plentiful ginger as a low-calorie meal because ginger is used as a flavoring for recipes such as ginger candy, ice cream, cookies, cakes, ginger ale, and ginger beer.

As you know, those items contain lots of sugar, sodium, milk, and/or wheat flour and those are high-calorie diets. The milk and wheat flour may cause the allergies that some people have.

On the other hand, konnyaku is made from the root of the konnyaku potato, a variety of the taro. Having origins in Indonesia or Ceylon, the konnyaku potato, once believed to have medicinal properties, has been cultivated for human consumption in Japan for centuries. Today, konnyaku is receiving wide attention as the new non-caloric health food.

But some people do hesitate to cook and eat the konnyaku products because they don't like the fishy smell of these. In fact, the items have a characteristic smell like a fish.

Therefore, taking only ginger flavor foods as a low-calorie diet without any allergies and konnyaku foods without fishy smell was considered impossible, whereas it had long been expected to become reality.

### SUMMARY OF THE INVENTION

Invention is a kind of things, processes and matters which is to turn impossibility into possibility.

According to the present invention, to begin with, add ginger powder (or paste) to a blender filled with water and blend for a few minutes. After that, add raw materials of konnyaku (konjac) powder.

A few hours later, add a coagulant (water mixed with calcium hydroxide powder) to the ginger konnyaku paste, shape noodles with basket or sieve which have meshes, and boil the noodles with hot water.

Finally, the ginger konnyaku noodles are ready.

### BRIEF DESCRIPTION OF THE DRAWINGS

The invention disclosed herein will be understood better with reference to the following drawings of which;

FIG. 1 is a view of a ginger powder (or ginger paste), raw materials of konnyaku (konjac) powder, and a cooking pot filled with water.

FIG. 2 is a view of the pot filled with the ginger konnyaku paste and a coagulant (mixed water with calcium hydroxide powder) to the paste.

FIG. 3 is a view of the ginger konnyaku paste and noodle, a basket that has meshes, and boiled water. There are ginger konnyaku noodle in other big pot filled with boiled water.

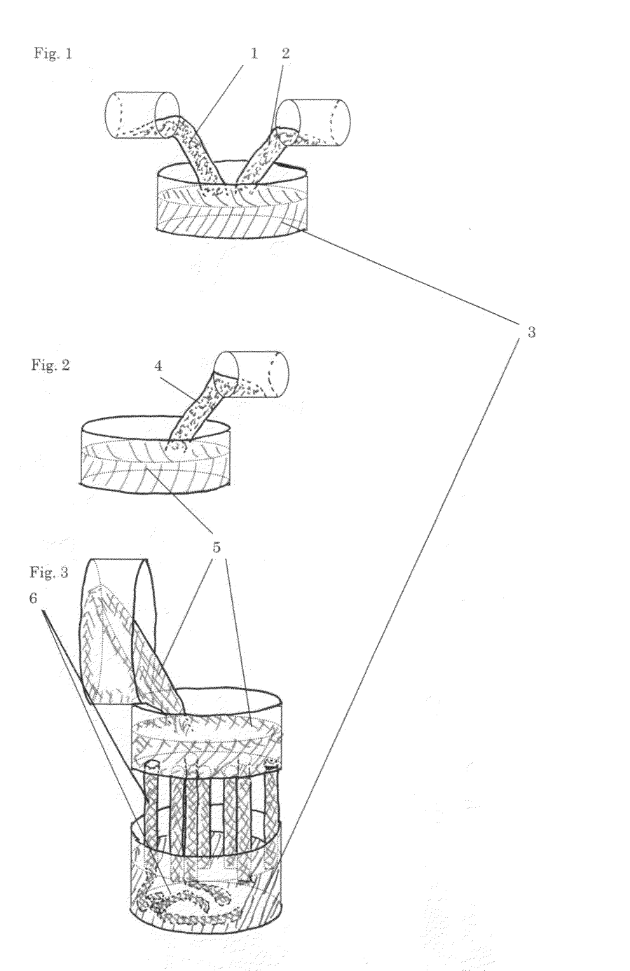

Referring to FIG. 1 and FIG. 2, there are shown a ginger powder (or ginger paste) 1, konnyaku powder 2, water 3, a coagulant to the ginger konnyaku paste 4, the konnyaku paste 5, and prepared ginger konnyaku noodle 6 in FIG. 3, ready for eat.

### DETAILED DESCRIPTION OF THE INVENTION

In my invention, prepare water, konnyaku (konjac) powder, a coagulate food comprising raw material of konnyaku, and ginger powder (or ginger paste). (FIG. 1).

In this case konnyaku powder is particularly used for this purpose since it has a specific nature of considerable low-calorie diet.

Then mix ginger powder (or ginger paste) and water in the pot. (FIG. 1).

After that, add the konnyaku powder and blend the ginger konnyaku paste in the pot. (FIG. 1).

A few hours later, shape noodles from the past with a basket or sieve which have meshes adding a coagulant (water mixed with calcium hydroxide powder) to the paste. (FIG. 2).

Put these noodles in a boiled water, and then a coagulate food (ginger konnyaku noodle) can be produced. (FIG. 3).

Furthermore, owing to the characteristic odor and flavor of ginger, the ginger konnyaku noodle does not have so much the characteristic smell like fish of the konnyaku products.

Thus, adding a ginger powder or paste to coagulate foods comprising raw material of konnyaku, people could enjoy these konnyaku food as a low-calorie diet without fishy smell.

In addition, this coagulate food can be eaten like ordinary noodles and pasta without sugar, milk, and so on.

What is claimed is:

1. Method for producing a coagulate food comprising raw material of konnyaku (konjac) and ginger powder or paste and said coagulate food. It's a ginger konnyaku (konjac) noodle (also called ito-konnyaku or shirataki).

2. To make any shapes of ginger konnyaku noodles. For example, it could be various types of pasta or rectangular, spherical forms.

3. To add ginger flavor as an odor eater to any other coagulate food comprising raw material of konnyaku (konjac).
